(19) United States
(12) Patent Application Publication
(10) Pub. No.: US 2005/0116956 A1
(43) Pub. Date: Jun. 2, 2005

(54) Message display

(76) Inventor: Paul Rowland Beardow, Surrey (GB)

Correspondence Address: Robert W J Usher, 1133 Broadway #1515, New York, NY, 10010, US

(21) Appl. No.: 10/483,365

(22) PCT Filed: May 29, 2002
(86) PCT No.: PCT/GB02/02490

(30) Foreign Application Priority Data
Jun. 5, 2001 (GB) 0113537.5

(51) Int. Cl. G10L 11/00

(52) U.S. Cl. 345/473; 345/611; 704/270.1

(57) ABSTRACT

A mobile radio handset (10, 24), capable of receiving short message service text messages (12), examines incoming text messages (12) to see if a recognised string of one or more characters is received and, in response thereto, retrieves and displays, on a display screen (14), a stored image (26, 28, 30, 32, 34) which is to be displayed whenever that string of characters is received. The image (26, 28, 30, 32, 34) can be shown alone or with the text (12) which triggered its display. The images (26, 28, 30, 32, 34) can be provided by the user of the handset (24), or derived from a server or central data base (80) in the mobile telephone network. The images (26, 28, 30, 32, 34) can include static images or animations. The static images can includes a photograph. As well as text messages (12), the Caller Location Identifier (CLI) of a caller can be used to evoke a display, chosen by the call recipient. The operation of the invention is compatible with handsets (10, 24) which can receive text messages (12) but which are not enabled for the invention.

The present invention relates to messaging. The invention particularly relates to alphanumeric messaging in a communications environment. Most particularly, the present invention relates to “text messaging” in a cellular or other radio telephone system.

Cellular radio telephones, designed primarily for duplex (two way) voice communication, are also adapted for simplex (one way) text messaging. A user types a message (using multi-stroke keying on the limited button set of the mobile telephone keypad) which is displayed on the user's screen. When the user is content with the content of the text message, the message is sent to the recipient or recipients of the user's choice. This is a simplex (one way) process. The text message is sent, and simply arrives. On arrival, the recipient's mobile telephone can ring (or not, as selected). In any event, the recipient is informed by sound (for example, the morse characters . . . -- . . . ), or display of an icon, or otherwise, that a “short message service” (SMS) message awaits his or her attention. When the recipient views a text message, alphanumeric and other script characters are displayed. Text messages are generally limited to having fewer than a predetermined number of characters (generally around one hundred), and so great ingenuity is required to construct a text message carrying more than a trivial amount of meaning.

As well as the use of abbreviations and spelling contraction to rival those used in morse code traffic, text messagers (a neologism for a sender or receiver of text messages) have, at their disposal, a number of icons to express abstract ideas. These icons are script characters, generally derived from the second part of the ASCII character set, and so take up no more space that the alphanumeric characters found in the first part of the ASCII character set. Such icons can include [symbol] . Those that express feeling are sometimes called EMOTICONS (emotional icons). Despite these extra symbols, the content of a text message is low and a little short on attention-getting or entertainment value. The present invention seeks to provide enhanced content for text messaging while staying within the character count restraint.

According to a first aspect, the present invention consists in a method for displaying a text message, said method including the steps of: identifying one or more consecutive characters in the text message string; employing said one or more consecutive characters to identify a display, and calling up and displaying the display in response to presentation of said one or more consecutive characters.

According to a first aspect, the present invention consists in a method for presenting script, said method including the steps of: recognising script as a pointer to display data in a database; employing said pointer to retrieve a display from the database; and displaying the display in response to the script.

According to another aspect, the present invention consists in an apparatus for presenting script, said apparatus comprising: means for recognising script; a database for containing display data; means to employ the recognised script as a pointer to display data in the database; means to employ said pointer to retrieve the display data from the database; and means for displaying the retrieved display in selected by the pointer.

The invention also provides for displaying the display in place of the script.

The invention also provides for displaying the display as well as the script.

The invention also provides that script can comprise a single character.

The invention also provides that the script can comprise a plurality of characters.

The invention also provides that at least some of the plurality of characters are adjacent to one another.

The invention further provides that the display can include a picture.

The invention further provides that the display can include an animation.

The invention further provides that the display can include a three dimensional construct.

The invention further provides that the three dimensional construct can be move to create an animated display.

The invention further provides that the database can comprise a plurality of display sets, it being selectable which display set is displayed.

The invention further provides that the database can obtain display data from a remote source.

The invention further provides that the remote source can include a server.

The invention further provides that remote source can include a camera.

The invention further provides that access to the remote source includes Internet access.

The invention further provides that access to the remote source includes telephone access.

The invention is further provided for use with a computer.

The invention further provides that the computer is connectable to an Internet service.

The invention is also provided for use with a mobile communications device.

The invention further provides that the mobile communications device can be a mobile telephone.

The invention further provides that script can be representative of a caller identity.

The invention further provides that the script can be selectable.

The invention further provides that display can be selectable.

The invention is further explained, by way of an example, by the following description, taken in conjunction with the appended drawings, in which:

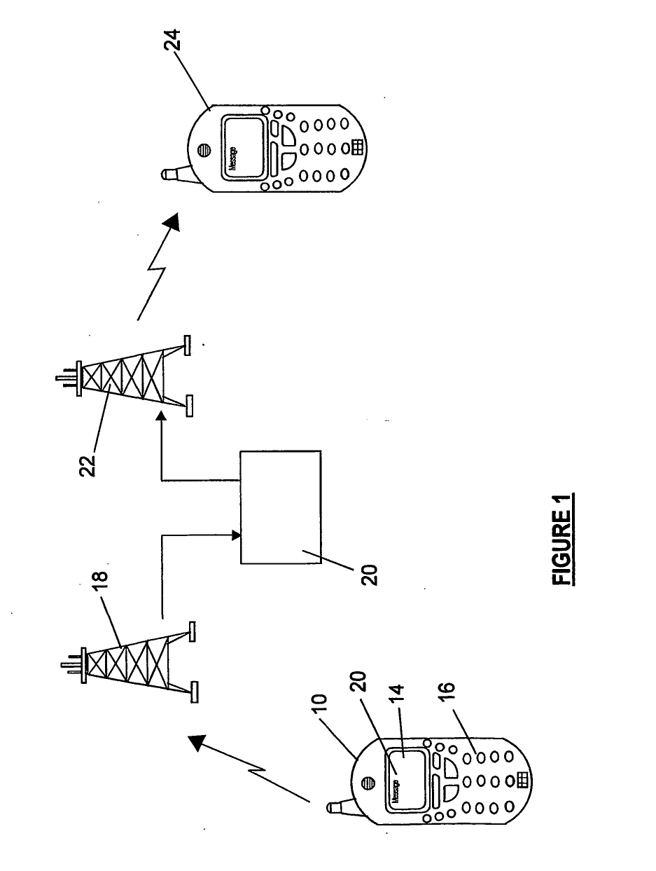

FIG. 1 is representative of the mobile telephone text messaging environment within which the embodiment of the invention is set.

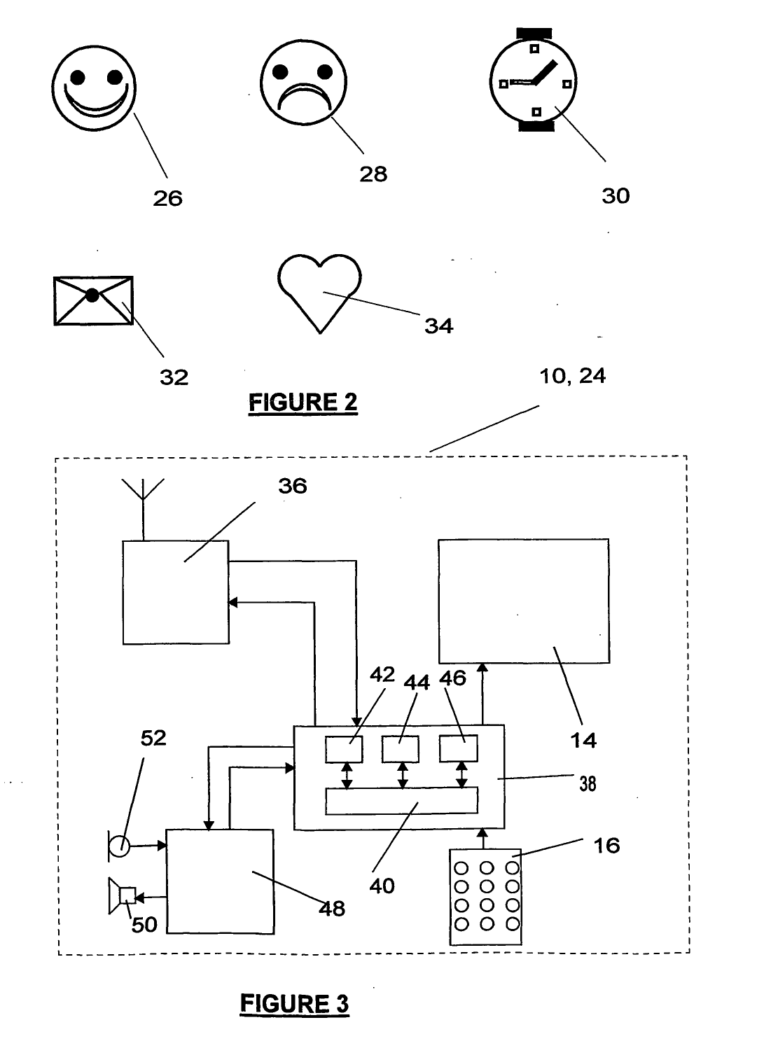

FIG. 2 shows some script characters currently used in text messaging.

FIG. 3 shows the general components of a mobile telephone, in as much as they apply to the embodiment.

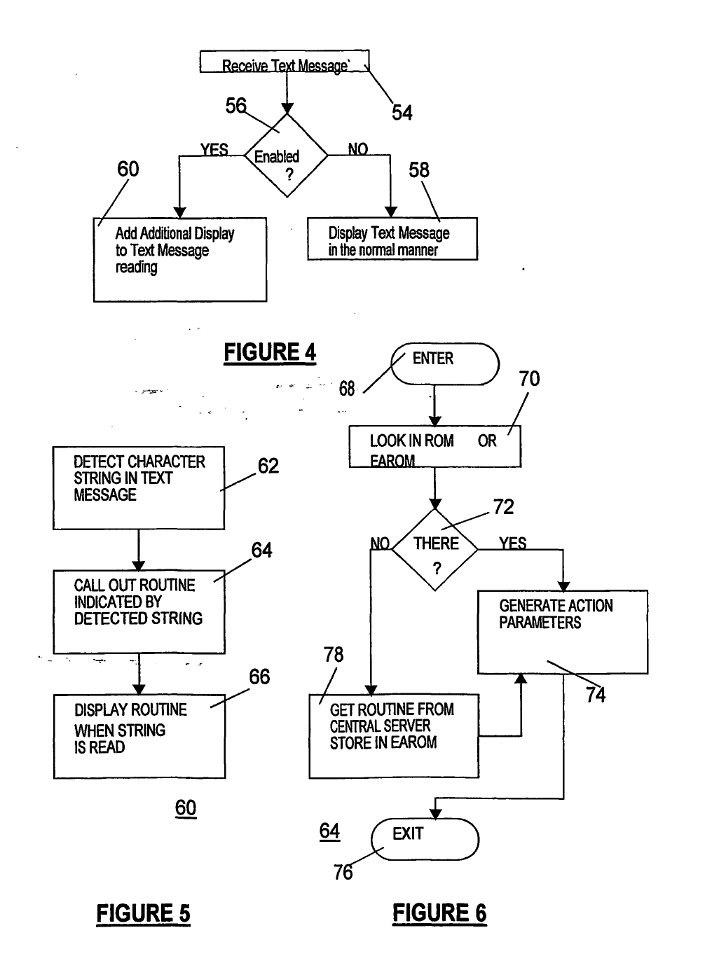

FIG. 4 is a flow chart of the manner in which a modified text message can be handled.

FIG. 5 is a flow chart showing how a modified text message can be displayed

FIG. 6 is a flow chart of retrieval activities for display routines.

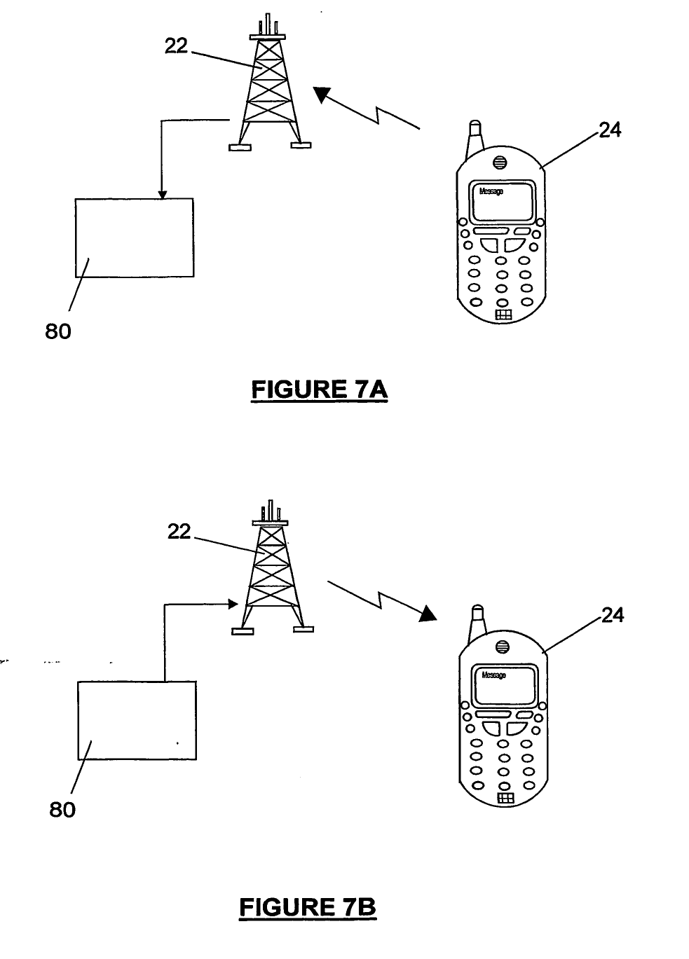

FIGS. 7A and 7B illustrate the environment and stages in which a display routine is retrieved from a data base.

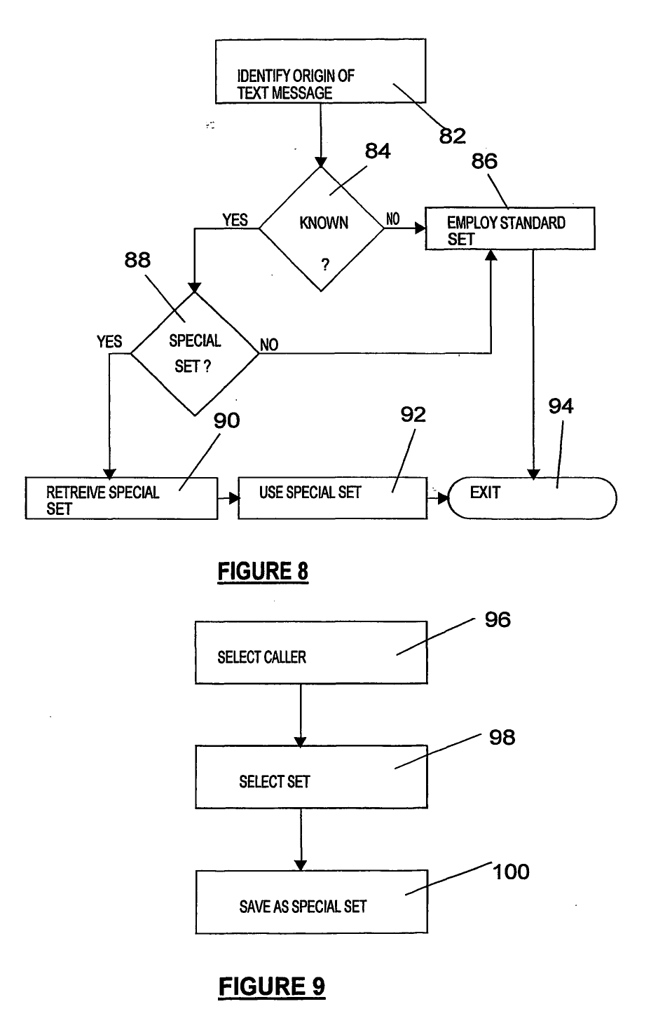

FIG. 8 is a flow chart showing how called identification can be used to trigger a preselected or later selected set of display routines.

FIG. 9 shows how a set of display routines-can be selected for a particular caller.

And

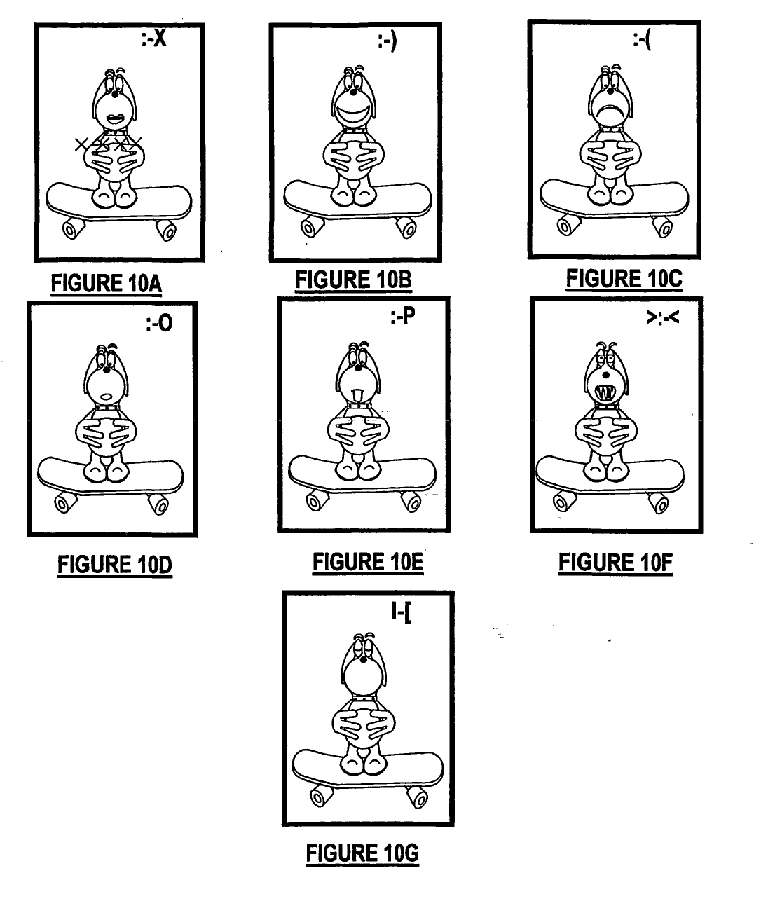

FIGS. 10A to 10G are examples of script substitutions which can be used with the present embodiment.

FIG. 1 shows the environment within which the present invention is applied. An originating handset 10 assembles a text message 12 on its screen 14 by means of the keyboard 16. When the text message 12 is acceptable, the user of the originating handset 10 sends the text message to a receiving base station 18 (usually the nearest base station, and the one with which the originating handset is, at that moment, registered) which transfers the text message, through the switched telephone network 20, to the transmitting base station 22 with which a receiving handset 24 is registered. The receiving base station 22 transmits the text message 12 to the receiving handset 24 which receives and stores the text message 12 automatically, and then announces its act of reception for the recipient, then or later, to view the text message 12.

FIG. 2 shows some of the icons used in text messaging. A smiling face [symbol] 26 denotes happiness. A scowling face [symbol] 28 denotes unhappiness or anger. A watch [symbol] 30 denotes time. An envelope [symbol] 32 denotes a message. A heart [symbol] 36 denotes love or affection. The list is endless. Some of the icons are simple extractions from the second ASCII symbol or character set. Others are substituted by the handsets 10 24 in response to particular keystrokes or data bytes. Other conventions have arisen, where a combination of punctuation characters such as “:-)” can be used, in this instance, to denote the smiley icon [symbol] 26. Almost non-iconic conventions have also arisen. For example CUL8R?:-) means “Can I see you later, and the idea makes me happy”. The present invention seeks to provide added utility responsively to changing conventions, both in iconic and abreviative contexts.

Attention is drawn to FIG. 3 showing a schematic diagram of the general parts in a handset 10, 24. No matter what the “generation” of mobile phone 10, 24, they all have the same parts shown in FIG. 3.

A radio frequency section 36 provides all the radio reception and radio transmission functions of the handset 10, 24. A controller 38 sends signals for transmission to, receives signals from, and provides operating instructions to, the radio frequency section 36. From the point of view of the present invention, it does not matter what frequency, transmission standard or other protocols the radio frequency section 36 has. All that matters is that, under instruction from the controller 38, messages can be sent and received.

The controller receives user input from the keyboard 16 and sends images to be displayed on the screen 14. The controller 38 comprises a central processor 40, similar to that found in any personal computer. The central processor 40 operates in conjunction with Random Access Memory (RAM), Read-Only Memory (ROM) 44 and Electrically Alterable Read Only Memory (EAROM) 46. The RAM 42 is the instantly functional memory, and deals with instant memory requirements. The RAM 42 loses all of its content when power is removed. The ROM 44 contains the programs and parameters which are essential for the processor 38 to function, and which never change. The ROM 44 retains its contents forever, and the contents cannot be changed. The EAROM 46 contains information which is, usually, permanent, but which might be changed on very rare occasions. The EAROM 46 retains its contents when power is removed, but its contents can be changed when special signals are provided. The memories 42 44 46 are in part on the circuit board which houses the controller 38, and in part (especially some ROM and EAROM) on the SIM card which is placed into a handset 10 24 and which provides portability between handsets for a user's network connections, personal preferences, phonebook etc. In addition, audio circuits 48 drive a speaker 50 and receive signals from a microphone 52, and interact with the controller 38 to provide the conversational nature of the handset 10 24.

Attention is drawn to FIG. 4, a brief flowchart showing how the present invention is compatible with handsets 10 24 not adapted for the present invention. A first operation 54 has the handset 10 24 receive a text message. The text message consists only of normal characters, known in “ordinary” text messaging. A first test 56 checks to see if the handset 10 24 is enabled to provide the additional display, with which the present invention is concerned. It the user has not enabled the additional display feature, a second operation 58 has the handset 10 24 display the text message in the normal manner. If the user has enabled the additional display feature, a third operation 60 has the handset 10 24 add the additional display of the present invention. If, however, the handset 10 24 is not of a type, adapted to operate according to the present invention, the text message is simply displayed, in the normal manner.

Attention is drawn to FIG. 5 which expands upon the third operation 60 of FIG. 4. A fourth operation 62 has the handset 10 24 examine the text message it has just received. The user of the handset 10 24 has not yet examined (read) the text message. The fourth operation 62 looks for character strings which the handset 10 24 will use as triggers for additional display, over and above the normal content of the text message. Thereafter, a fifth operation 64 calls out the display routine which is indicated by each triggering character string. A sixth operation 66 then causes the provision of a respective additional display, indicated by each triggering character string, whenever the part of the text message containing the triggering character string is read.

Attention is drawn to FIG. 6, expanding upon the fifth operation 64 of FIG. 5. Entry 68 from the fourth operation 64 is to a seventh operation 70 where the handset 10 24 looks in its ROM 44 and/or its EAROM 46 to see if instructions exist to generate the additional display called out by a character string in the text message. Some routines will permanently be stored in the ROM 44. Other routines will have been acquired over time, and will have been stored in the EAROM 46. If a second test 72 detects that the appropriate routine is already stored, an eighth operation 74 generates the action parameters, from the stored routine, ready to be used in the sixth operation 66 to which exit 76 is made. If the second test 72 does not detect that the required routine is stored in the ROM 44 or EAROM 46, a ninth operation 78 gets the required routine from a central server, stores the acquired required routine in the EAROM 46 for further use at a later time, and passes control to the eighth operation 74 where the action parameters are generated for use in the sixth operation 66.

Attention is drawn to FIGS. 7A and 7B, illustrating the action of the ninth operation 78 of FIG. 6. Lacking the required routine, in FIG. 7A, the receiving handset 24 automatically puts in a call through the receiving base station 22 to a central data base 80 connected to the switched telephone network. The database 80 seeks out the required routine, and, in FIG. 7B, sends the required routine, back through the switched telephone network and the receiving base station 22, to the receiving handset 24. The receiving handset 24 then stores the required routine in the EAROM 46. If the EAROM 46 is on the SIM card, the routine is made portable from handset 24 to handset 24 when the user changes service supplier or handset model.

While it is preferred that the transfer of the request for the required routine from the receiving handset 24, and the transfer of the required routine to the receiving handset 24 are all in the space of a single automatic call, originating from the receiving handset 24, the invention also provides that the data base 80, if a delay is unavoidable, can respond to the receiving handset 24 by placing a second (non-ringing) automatic call to the receiving handset 24.

Attention is drawn to FIG. 8, a flowchart illustrating how a user can select what style of additional images are automatically displayed when a text message is received.

When a text message is received, a tenth operation 82 examines the CLI (Caller Location Identifier), a coded message which accompanies each call (text or voice) and which serves to indicate, to the user, the origin of the call. This feature is well known in the art. In general, the CLI is used to consult the user's stored “phone book” and to display the name of the caller. As a default, no display or number display alone can be provided. The present invention puts the CLI to a further use. The tenth operation 82 checks the CLI. If a third test 84 detects that the sender of the text message is not in the receiving handset's 24 phone book, an eleventh operation selects the standard (default) set of routines to be displayed. If the third test 84 detects that the sender of the text message is in the phone book of the receiving handset 24, a fourth test 88 checks to see if the user of the receiving handset 24 has selected a special set of routines to be used when that particular text message sender sends a text message. If the user has not selected a special set for that text message sender, the eleventh operation 86 employs the standard (default) set of routines. If the user of the receiving handset 24 has selected a special set of routines for that particular text message sender, a twelfth operation 90 retrieves the special set of routines (which may involve the operations of FIGS. 7A and 7B) and a thirteenth operation 92 employs the selected special set when generating additional images for use when reading the text message. Exit 94 can be to the first operation 54 of FIG. 4.

FIG. 9 is a flow chart illustrating how the user of the receiving handset 24 can apply a special set of routines for a particular caller (text messager). In a fourteenth operation 96, having opened the phone book in the receiving handset 24, the user selects a particular caller from the list. In a fifteenth operation 98 the user selects a “Display Set” menu and selects an appropriate set of routines. A sixteenth operation 100 then stores the identity of selected set for selection and use as illustrated with reference to FIG. 8.

FIGS. 10A to 10B show examples of one set (usable as the default set) of images which can be called up by the present invention. Within each image is an example of a character string which can call up that image. The character is a dog, holding a ball. In FIG. 10A the dog is blowing kisses. In FIG. 10B the dog is happy. In FIG. 10C the dog is sad. In FIG. 10D the dog is surprised. In FIG. 10E the dog is sticking out its tongue. In FIG. 10F the dog is angry. In FIG. 10G the dog is asleep. Other sets can have different creatures, different poses, and different call-up codes.

The examples, given in FIG. 10, are of static images. The routines, called up, according to the invention, can equally be short animations, generated by a series of billboards, or created by movement of a three dimensional model projected for the two dimensional screen 14. The images or animations can be interspersed between letters in the text message, or can be used to fill the whole or part of the screen 14 as a character string “enters stage right” or “exits stage left”

The user, of the receiving handset 24, in the twelfth operation 90 (of FIG. 8) can specify particular or new character strings to bring up images selected by the user, and can do so with images received from the database 80. For example, if the word “Love” appears, the user can specify that an image or animation of a throbbing heart appears. If the name of someone hated appears, an image of a dagger or an animation of a stabbing, or some such instrument or action can be specified to appear. The present invention also encompasses a selected image or animation being selected for each caller, the selected image or animation being retrieved instead of the caller's identity or number, so that the caller may be visually identified by the recipient, even for ordinary voice calls.

The present invention also encompasses that a user can insert images or animations, not from a stock library or database, but loaded into the handset from a digital camera, or by connection to a computer, or by insertion of a specially pre-programmed or pre-loaded card.

1-48. (canceled)

49. A method for presenting script, said method comprising the steps of: recognising at least one character of script as a pointer to display data in a database; employing said pointer to retrieve a display from the database; and displaying the display in response to the script.

50. A method according to claim 49, comprising displaying said display in place of said script.

51. A method according to claim 50, wherein said script comprises a single character.

52. A method according to claim 50, wherein said script comprises a plurality of characters and wherein at least some of said plurality of characters are adjacent to one another.

53. A method according to claim 50, wherein said display comprises a picture.

54. A method according to claim 50, wherein said display comprises an animation.

55. A method according to claim 53, wherein said display comprises a three-dimensional construct.

56. A method according to claim 55, further comprising causing the three-dimensional construct to be moved to create an animated display.

57. A method according to claim 50, wherein said database comprises a plurality of display sets, and the method further comprises selecting which display set is displayed.

58. A method according to claim 50, further comprising obtaining display data for said database from a remote source.

59. A method according to claim 58, wherein said remote source comprises a server.

60. A method according to claim 58, wherein said remote source comprises a camera.

61. A method according to claim 59, wherein access to said remote source comprises Internet access.

62. A method according to claim 58, wherein access to said remote source comprises telephone access.

63. A method according to claim 50, for use with a computer.

64. A method according to claim 63, further comprising connecting said computer to an Internet service.

65. A method according claim 50, for use with a mobile communications device.

66. A method according to claim 65, wherein said mobile communications device is a mobile telephone.

67. A method according to claim 65, further comprising utilising the script to represent a caller identity.

68. A method according to claim 50, wherein said script is selectable.

69. A method according to claim 50, wherein said display is selectable.

70. A method according to claim 50, wherein said database is within the receiving device.

71. A method according to claim 50, further comprising storing the database on a portable memory device.

72. A method according to claim 49, comprising displaying said display as well as said script.

73. A method according to claim 72, wherein said script comprises a single character.

74. A method according to claim 72, wherein said script comprises a plurality of characters and wherein at least some of said plurality of characters are adjacent to one another.

75. A method according to claim 72, wherein said display comprises a picture.

76. A method according to claim 72, wherein said display comprises an animation.

77. A method according to claim 75, wherein said display comprises a three-dimensional construct.

78. A method according to claim 77, further comprising causing the three-dimensional construct to be moved to create an animated display.

79. A method according to claim 72, wherein said database comprises a plurality of display sets, and the method further comprises selecting which display set is displayed.

80. A method according to claim 72, further comprising obtaining display data for said database from a remote source.

81. A method according to claim 80, wherein said remote source comprises a server.

82. A method according to claim 80, wherein said remote source comprises a camera.

83. A method according to claim 81, wherein access to said remote source comprises Internet access.

84. A method according to claim 80, wherein access to said remote source comprises telephone access.

85. A method according to claim 72, for use with a computer.

86. A method according to claim 75, further comprising connecting said computer to an Internet service.

87. A method according claim 72, for use with a mobile communications device.

88. A method according to claim 87, wherein said mobile communications device is a mobile telephone.

89. A method according to claim 87, further comprising utilising the script to represent a caller identity.

90. A method according to claim 72, wherein said script is selectable.

91. A method according to claim 72, wherein said display is selectable.

92. A method according to claim 72, wherein said database is within the receiving device.

93. A method according to claim 72, further comprising storing the database on a portable memory device.

94. A method for presenting script, said method comprising the steps of: recognising at least one character of script as a pointer to display data in a database; employing said pointer to retrieve a display from the database; and displaying the display in response to the script, wherein said display comprises an animation and a three-dimensional construct.

95. A method according to claim 94, for use with a mobile communications device.

95. A method according to claim 95, wherein said mobile communications device is a mobile telephone.

97. A method according to claim 95, further comprising utilising the script to represent a caller identity.

98. A method for presenting script, said method comprising the steps of: recognising at least one character of script as a pointer to display data in a database; employing said pointer to retrieve a display from the database; and displaying the display in response to the script, wherein said display comprises a picture and a three-dimensional construct.

99. A method according to claim 98, for use with a mobile communications device.

100. A method according to claim 99, wherein said mobile communications device is a mobile telephone.

101. A method according to claim 99, further comprising utilising the script to represent a caller identity.

102. A method for presenting script, said method comprising the steps of: recognising at least one character of script as a pointer to display data in a database; employing said pointer to retrieve a display from the database; displaying the display in response to the script; and utilising the script to represent a caller identity, wherein said method is implemented on a mobile telephone.

103. A method according to claim 102, wherein said script is selectable.

104. A method according to claim 102, wherein said display is selectable.

105. A method for presenting script, said method comprising the steps of: obtaining display data from a remote source, such as a server; recognising at least one character of script as a pointer to the display data stored in a database; employing said pointer to retrieve a display from the database; and displaying the display in response to the script, wherein access to said remote source comprises Internet access and said database is provided within a device receiving the display data.

106. A method according to claim 105, wherein said display is selectable.

107. A method for presenting script, said method comprising the steps of: obtaining display data from a remote source, such as a camera; recognising at least one character of script as a pointer to the display data stored in a database; employing said pointer to retrieve a display from the database; and displaying the display in response to the script, wherein said database is stored within a device receiving the display data.

108. A method according to claim 107, wherein said display is selectable.

109. A method for presenting script, said method comprising the steps of: recognising at least one character of script as a pointer to display data in a database; employing said pointer to retrieve a display from the database; and displaying the display in response to the script, wherein said display comprises an animation of a three-dimensional construct, and said method is implemented on mobile telephone.

110. An apparatus for presenting script, said apparatus comprising: means for recognising script as a pointer to display data in a database; means to employ said pointer to retrieve a display image from the database; and a screen to display the display image in response to the script.

111. An apparatus according to claim 110, wherein said screen is operative to display said display image in place of said script.

112. An apparatus according to claim 110, wherein said screen is operative to display said display image as well as said script.

113. An apparatus according to claim 110, wherein said script comprises a single character.

114. An apparatus according to claim 110, wherein said script comprises a plurality of characters.

115. An apparatus according to claim 112, wherein at least some of said plurality of characters are adjacent to one another.

116. An apparatus according to claim 110, wherein said display image comprises a picture.

117. An apparatus according to claim 110, wherein said display image comprises an animation.

118. An apparatus according to claim 116, wherein said display comprises a three-dimensional construct.

119. An apparatus according to claim 118, further comprising means for moving said three-dimensional construct to create an animated display.

120. An apparatus according to claim 110, wherein said database comprises a plurality of display sets and means for selecting which display set is displayed.

121. An apparatus according to claim 110, wherein said database is operative to obtain display data from a remote source.

122. An apparatus according to claim 121, wherein said remote source comprises a server.

123. An apparatus according to claim 121, wherein said remote source comprises a camera.

124. An apparatus according to claim 122, wherein access to said remote source comprises Internet access.

125. An apparatus according to claim 121, wherein access to said remote source comprises telephone access.

126. An apparatus according to claim 110, where in the apparatus comprises a computer.

127. An apparatus according to claim 126, wherein said computer is connectable to an Internet service.

128. An apparatus according to claim 110, wherein the apparatus comprises a mobile communications device.

129. An apparatus according to claim 148, wherein said mobile communications device is a mobile telephone.

130. An apparatus according to claim 129, wherein said script is representative of a caller identity.

131. An apparatus according to claim 110, wherein said script is selectable.

132. An apparatus according to claim 110, wherein said display image is selectable.

133. An apparatus according to claim 110, wherein said database is stored within the apparatus.

134. An apparatus for presenting script, the apparatus comprising an interpreter for recognising script as a pointer to display data in a database; a reading module arranged to employ the pointer to retrieve display data from the database and a screen arranged to display the display image in response to the script.
